(19) United States
(12) Patent Application Publication
(10) Pub. No.: US 2006/0187751 A1
(43) Pub. Date: Aug. 24, 2006

(54) Device for mixing two fluids and use thereof for cooling a very high temperature fluid

(75) Inventors: Michel Lepine, Ferriere La Grande (FR); Dominique Cucini, Jeumont (FR)

Correspondence Address: CONNOLLY BOVE LODGE & HUTZ LLP, SUITE 800, 1990 M STREET NW, WASHINGTON, DC, 20036-3425, US

(73) Assignee: JEUMONT S.A., Courbevole (FR)

(21) Appl. No.: 10/565,827

(22) PCT Filed: Jun. 9, 2004
(86) PCT No.: PCT/FR04/01439

§ 371 Date: Jan. 25, 2006

(30) Foreign Application Priority Data
Jul. 29, 2003 (FR) 03/09341

(51) Int. Cl. B01F 5/00; B01F 15/00

(52) U.S. Cl. 366/336

(57) ABSTRACT

The device comprises a tubular casing (2) having a first coupling element (5) for feeding it with a first fluid at a first axial end, and a second coupling element (6) for exhausting a mixture of the first fluid and a second fluid at a second axial end. An internal fluid guide duct (18a, 18b) is placed coaxially inside the casing (2) of the mixer. The device further includes a third coupling element (7) in a lateral position passing through the casing (2) between the first coupling element (5) and the second coupling element (6) and opening out into a cylindrical chamber (3) of the mixer in a position facing the outer surface of the guide duct (18a, 18b). The guide duct (18a, 18b) may be made up of two portions and comprises a wall having an insulating space (19a, 19b) formed therein, which space is put into communication with the cylindrical chamber (3). The device of the invention can be used in particular for cooling supercritical water used in a process of oxidizing effluent in supercritical water.

The invention relates to a device for mixing a first fluid at a first temperature together with a second fluid at a second temperature.

In certain industrial processes, there is a need to mix first and second fluids at temperatures that are very different from each other.

For example, when treating organic effluent by oxidizing it in water under supercritical conditions, a residual fluid is obtained at the end of the treatment that is constituted mainly by water at very high temperature (e.g. about 550° C.) and at very high pressure.

This fluid needs to be cooled and depressurized, and possibly also subjected to further treatment, e.g. chemical neutralization, in order to enable it to be discarded or possibly stored in collection tanks or receptacles.

The known method of hydrothermally oxidizing organic effluent in supercritical water consists in putting the effluent into contact with water at very high temperature and very high pressure in the presence of oxygen so as to destroy organic molecules by reactions that are generally exothermic and that raise the temperature and the pressure of the water up to levels that are above those corresponding to the critical point of water (22.1 megapascals (MPa) and 374° C.). Water in the supercritical condition is a solvent that is extremely powerful and that is capable of destroying organic molecules in a period lying in the range 1 second to 1 minute, depending on the temperature stability of the molecules.

The method can be used in particular for treating chemical gases, herbicides, wastewater treatment sludge, chemical factory waste, or nuclear waste.

Under all circumstances, the effluent molecules are transformed into substances that are not environmentally harmful, such as carbon dioxide CO₂, water, and molecular nitrogen.

When treating substances of the organochlorine type, hydrochloric acid HCl is formed and can be neutralized by injecting a solution of caustic soda into the residual fluid from the treatment, with the caustic soda neutralizing the hydrochloric acid in the form of sodium chloride NaCl.

In supercritical water oxidation methods that have already been implemented, the residual fluid, which is constituted to a very large extent by water, can be at a temperature that is as high as 550° C. and at a pressure that is substantially greater than the critical pressure of 22.1 MPa.

Such conditions of pressure and temperature make it impossible to use heat exchangers of conventional type that implement heat exchange between two fluids through a wall in order to cool the residual fluid down to ambient conditions. However, in an industrial process, it is generally possible to use heat exchangers that enable water to be lowered from a temperature of about 300° C., i.e. a temperature that is substantially lower than the critical temperature of water, down to ambient temperature, e.g. 20° C.

Thus, when treating organic waste in supercritical water, it remains necessary to have a method and devices available that enable the water to be cooled from its starting temperature of about 550° C. to a temperature of about 300° C.

To do this, proposals have been made to use coaxial type heat exchangers in which the stream of fluid at very high temperature flows inside a central tube surrounded by a coaxial cooling chamber in which a stream of water at a temperature of about 20° C. is caused to flow. Such heat exchangers need to be of very great length and require the use of extremely expensive refractory materials, such as titanium, in particular for making the tube carrying the flow of residual fluid at very high temperature.

Proposals have also been made to mix the residual fluid at very high temperature with a fluid at a temperature that is substantially lower and that optionally contains various reagents. The high temperature fluid is introduced into a duct and is caused to flow therealong, and the cooling and treatment fluid is injected into the stream of high temperature fluid in such a manner that the fluids are mixed by the high temperature fluid and the cooling and treatment fluid flowing coaxially in a common flow direction. The mixture of fluids is recovered at the outlet from the duct constituting a mixer chamber. The cooling and treatment fluid is injected into the inside of the high temperature fluid flow duct by means of a coaxial second duct passing through the wall of the duct conveying the flow of high temperature fluid. The cooling fluid injection duct and certain portions of the high temperature fluid flow duct are then subjected to very high temperature gradients across their walls, which makes it very difficult to design structures that can withstand such gradients. In addition, when cooling a fluid that is mainly constituted by water in the supercritical state, the portions of the ducts that come into contact with the supercritical water are subjected to very high levels of corrosion, so it is necessary to use materials that can withstand corrosion, such as titanium or nickel alloys, in order to make these portions of the ducts.

The object of the invention is thus to provide a device for mixing a first fluid at a first temperature with a second fluid at a second temperature, the fluids being mixed in the form of coaxial streams flowing in the same direction, the device comprising a generally cylindrical tubular casing having a substantially rectilinear axis defining a cylindrical mixer chamber coaxially inside the casing and comprising, at a first axial end, a first coupling element for coupling to first fluid feed means, and at a second axial end, opposite from the first, a second coupling element for coupling to means for exhausting the mixture of the first and second fluids, and at least one guide duct for guiding at least one of the first and second fluids, the at least one duct being substantially rectilinear and disposed coaxially inside the mixer chamber, in which the device enables the fluids to be mixed together under good conditions, with temperature gradients in the various casings and tubular ducts of the device being limited.

To this end, the device comprises a third coupling element for coupling the mixer chamber to second fluid feed means, the third coupling element being in a position in the axial direction that is intermediate between the first and second coupling elements and extending in a transverse direction that is substantially perpendicular to the axial direction, and the guide duct extends axially in the mixer chamber between the first coupling element and a zone of the mixer casing downstream from the third coupling element in the direction going from the first coupling element to the second, and comprises a tubular wall including at least one coaxial insulating internal annular space in communication with a zone of the mixer chamber, said space extending substantially over the entire length of the guide duct, the third coupling element opening out into the mixer chamber so as to face an outside surface of the wall of the guide duct.

The device of the invention may also present, in isolation or in combination, the following characteristics:
the guide duct comprises both a first tubular duct extending axially inside the mixer chamber from the first coupling element at one axial end of the mixer chamber and a second tubular duct having a diameter greater than the outside diameter of the first tubular duct and disposed coaxially relative to the first tubular duct and the mixer casing, having a first axial end inside the cylindrical chamber with an end portion of the first tubular duct engaged therein, and a second axial end downstream from the third coupling element that opens out into the mixer chamber facing the outside surface of the wall of the second tubular duct, in such a manner that the second fluid introduced into the mixer chamber via the third coupling element flows in an annular zone of the mixer chamber that is closed at the second axial end of the second tubular duct, flowing axially towards the first end of the second tubular duct, and then, in the opposite direction, inside the second tubular duct between the first and second axial ends of the second tubular duct, the first and second fluids mixing in the form of coaxial streams flowing in the same direction in a mixing zone inside the second tubular duct;
each of the first and second tubular ducts is constituted by a set of coaxial shells engaged one on another and including wall portions of reduced thickness so as to leave between them coaxial annular spaces, and pierced by openings putting the coaxial annular spaces into communication with a medium outside the tubular duct in the mixer chamber; and
the second tubular duct includes an inner shell projecting from one of its axial ends relative to the set of shells of the second tubular duct in order to be engaged around the first tubular duct with radial clearance and pierced by openings for passing fluid into an annular space between the outer surface of the first tubular duct and the inner surface of the inner shell of the second tubular duct.

The device may be used in particular for mixing a first fluid mainly constituted by supercritical water used for treating effluents by oxidation in supercritical water, together with a second fluid mainly constituted by cooling water at a temperature that is substantially less than the temperature of the first fluid.

Under such circumstances, the first fluid is at a temperature of 550° C. and the second fluid at a temperature of about 20° C.

In order to make the invention well understood, there follows, with reference to the accompanying figures, a description by way of example of a plurality of embodiments of a mixer device of the invention used for cooling a fluid at very high temperature and at high pressure coming from a reactor for oxidation in supercritical water.

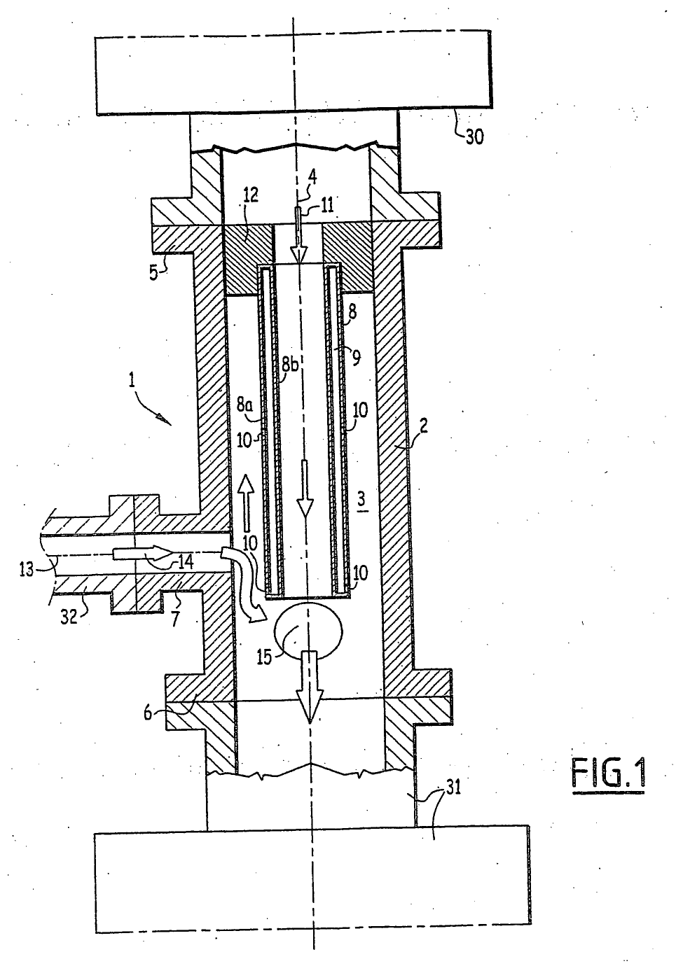

FIG. 1 is a diagrammatic axial section view of a mixer of the invention in a first embodiment.

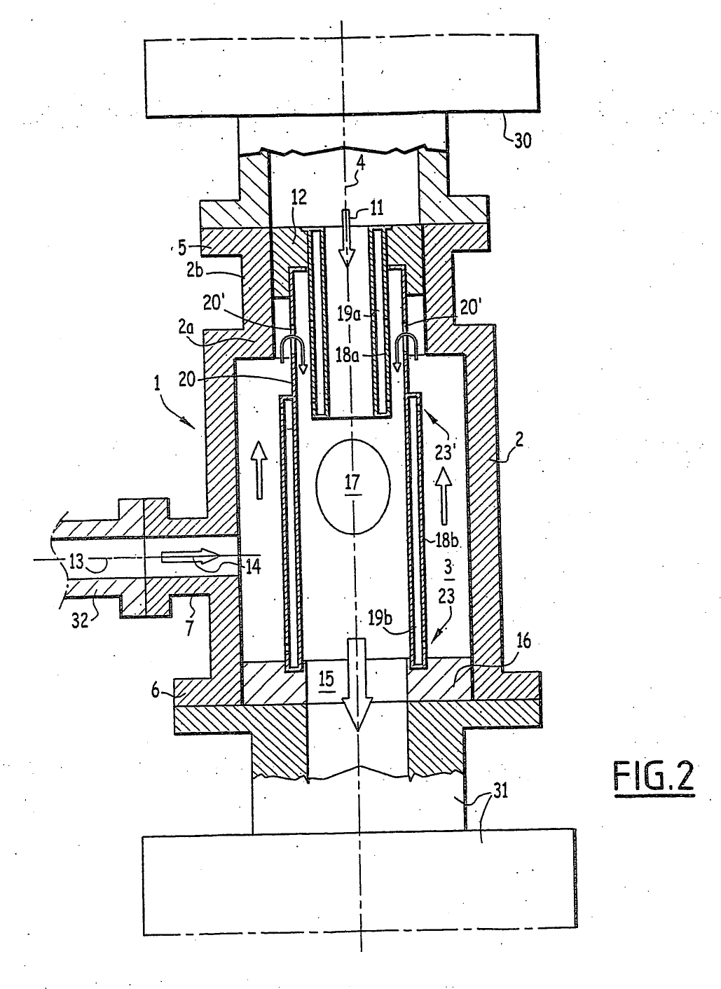

FIG. 2 is a diagrammatic axial section view of a mixer of the invention in a second embodiment.

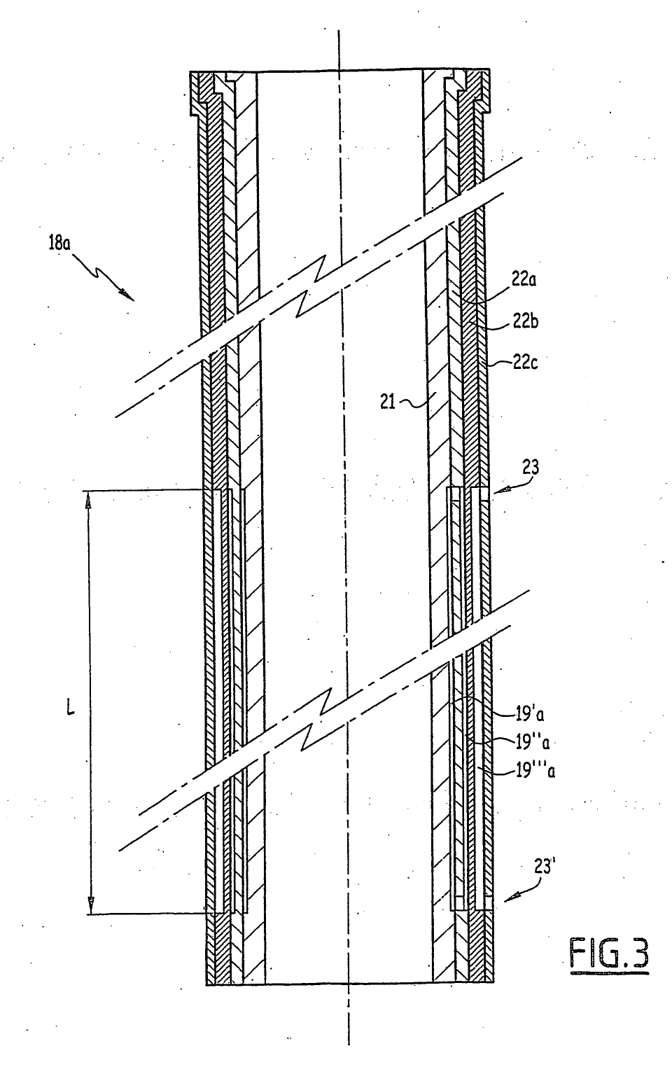

FIG. 3 is an axial section view on a larger scale of a first tubular duct of the mixer shown in FIG. 2 for guiding the first fluid, and constituted by shells engaged one on another.

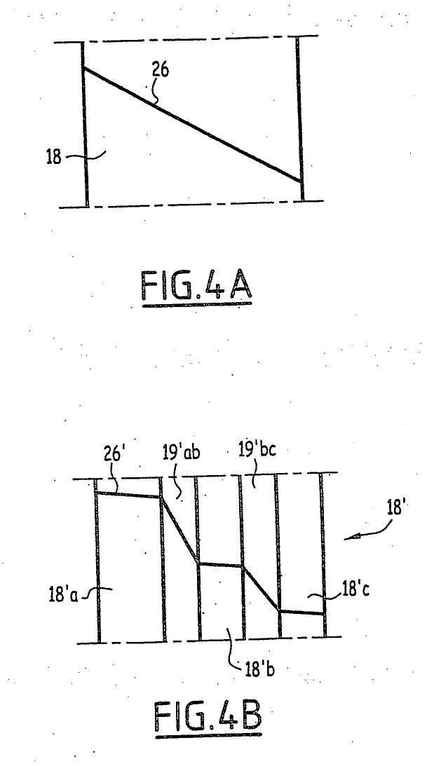

FIGS. 4A and 4B are diagrammatic section views of tubular duct walls showing temperature variations inside the walls of the tubular ducts that are exposed on their outside and inside surfaces to fluids at different temperatures.

FIG. 4A relates to a solid wall.

FIG. 4B relates to a wall of the invention including annular internal spaces filled with fluid.

FIG. 1 is a diagrammatic view of a mixer device of the invention given overall reference 1, comprising an outer casing 2 of generally tubular cylindrical shape defining an internal cylindrical mixer chamber 3, the casing 2 and the cylindrical chamber 3 sharing a common longitudinal axis 4 of the mixer.

At a first axial end, the casing 2 has a first coupling element 5 for admission which may be constituted by an opening surrounded by a flange enabling the mixer 1 to be coupled to means for feeding a first fluid, e.g. an outlet duct from a reactor 3 for oxidizing effluent in supercritical water, and constituting the first fluid that is to be cooled by mixing inside the mixer 1. Under such circumstances, the first fluid is constituted for the most part by supercritical water at a temperature close to 550° C. and at a pressure of about 25 MPa.

At a second axial end opposite from the end 5, the mixer casing 2 has a second coupling 6 for exhaust which may be constituted by an opening surrounded by a flange for coupling the mixer to a duct for exhausting the mixture, i.e. cooled water, e.g. water cooled down to a temperature of 300° C. The exhaust duct connected to the coupling element 6 can provide a junction between the mixer and a heat exchanger 31 enabling the mixed fluid that is obtained at the outlet from the mixer to be cooled down to ambient conditions.

The casing 2 also includes a third coupling element 7 that may be constituted by a branch connection and a flange enabling the mixer to be connected to means for feeding it with cooling fluid, e.g. to a cooling water tank and pumping installation serving to inject into the cylindrical chamber 3 of the mixer water at a temperature of about 20° C. and at a pressure slightly greater than the pressure of the first fluid, i.e. slightly greater than 25 MPa.

Inside the cylindrical chamber 3 of the mixer, in a coaxial disposition, there is mounted a guide duct 8 whose tubular cylindrical wall includes one or more coaxial internal annular spaces 9 extending substantially over the entire axial length of the guide duct 8 and defined between coaxial tubular elements of small thickness.

In order to simplify the drawing, FIG. 1 shows a guide duct 8 including a single annular space 9 between an outer wall element 8a and an inner wall element 8b.

The outer wall element 8a of the guide duct 8 is pierced by openings 10 of small dimensions (e.g. having a diameter of millimeter order) that are distributed around the circumference of the tubular duct in two zones located close to the axial ends of the guide duct. The openings 10 put the internal annular space 9 of the wall 8 into communication with the cylindrical chamber 3 of the mixer. In this manner, while the mixer is in operation, the internal annular space 9 in the wall of the tubular duct 8 is filled with water that is in a practically stagnant state. As explained below, this water-filled annular space provides a degree of insulation and puts a limit on the temperature gradient in the radial direction through the wall of the guide duct 8.

At one of its axial ends, the guide duct 8 is connected to the casing of the mixer at the first coupling element 5 in such a manner that the first fluid (as represented by arrow 11) flows along the axis 4 inside the guide duct 8. The duct 8 is preferably secured to the casing 2 of the mixer via an annular part 12.

The third coupling element 7 is located as far as possible away from the first coupling element so as to keep apart the introduction zones into the casing 2 of the mixer for the first fluid at very high temperature and for the second fluid constituted by water at about 20° C. The distance between the first and third coupling elements is a little less than the total length of the casing 2 of the mixer in the direction of the axis 4 (e.g. a little less than 1 meter). The third coupling element 7 is directed along an axis 13 that is substantially perpendicular to the longitudinal axis 4 of the mixer, the direction of the third coupling element via which the second fluid is introduced into the cylindrical chamber 3 (represented by arrow 14) being lateral or radial relative to the casing of the mixer.

The third coupling element connected to a cooling water feed duct 32 is located in such a manner as to open out into the cylindrical enclosure 3 in a position that faces a portion of the outside surface of the guide duct 8 that extends in the axial direction 4 away from the first coupling element 5 to a zone 15 in the cylindrical chamber 3 that is situated downstream from the third coupling element 7 (downstream relative to the flow direction of the first fluid along the axis, as represented by arrows 11). The cooling water that is introduced into the cylindrical chamber 3 at a pressure slightly greater than the pressure of the first fluid comes into contact with the outside surface of the tubular duct 8 and is distributed along its axial length about said duct 8 inside the cylindrical chamber 3. The introduction of cooling water ensures that the casing 2 in the vicinity of the third coupling element 7 is maintained at a temperature close to the temperature of the cooling water. In addition, the cooling water flows towards the outlet from the mixer via the second coupling element 3 in a direction that is substantially axial, and encounters the flow of the first fluid at high temperature flowing inside the guide duct 8. At the outlet from the guide duct 8, in the zone 15, the cooling water mixes with the first fluid at very high temperature, and the cooled mixture is recovered at the outlet from the mixer via the second coupling element 6. The flow of cooling water introduced into the cylindrical casing is adjusted in such a manner that the temperature of the mixture recovered at the outlet from the mixer is close to 300° C.

When the mixer is in operation, the first coupling element 5 is at the temperature of the first fluid, e.g. 550° C., while the third coupling element 7 is at a temperature of about 20° C. The axial temperature gradient between the first and third coupling elements has a value that is high in a zone of the casing 2 of cylindrical shape between the first and second coupling elements. The high axial temperature gradient in this zone of the casing has no effect on the behavior of the casing, since the gradient extends in a zone that is entirely axially symmetrical. In addition, the coupling elements are at temperatures that are entirely uniform and constant, namely the temperatures of the first and second fluids. Similarly, the temperature gradient between the second coupling element 6 at the outlet from the mixer, and the third coupling element, lies in a zone of the casing of the mixer that is cylindrical, and this has no effect on its behavior in operation.

On its inside surface, the guide duct 8 is in contact with the first fluid at high temperature, while on its outside surface it is in contact with the cooling second fluid inside the cylindrical chamber 3.

The temperature gradient in the radial direction through the wall of the guide duct 8 is thus high, at least in some zones of the wall of the guide duct 8. The presence of at least one annular space 9 that is filled with fluid, i.e. water, serves to restrict the value to the gradient through the wall elements 8a and 8b of the guide duct 8 to values that are small, with the insulating layer constituted by the water filling the space 9 absorbing the major part of the temperature difference between the inside surface of the guide duct 8 in contact with the first fluid at 550° C. and the outside surface in contact with the cooling water at 20° C. inside the cylindrical chamber 3.

FIG. 2 is a diagrammatic view showing a second embodiment of a mixer of the invention.

Corresponding elements that appear in both FIGS. 1 and 2 are identified by the same references. The essential differences between the devices in the first and second embodiments relate to the shape of the casing 2 of the mixer 1 and to the use of a guide duct in two portions 18a and 18b, each constituted by a tubular duct that is disposed and held coaxially inside the casing 2 of the mixer.

The first tubular duct constituting the first portion 18a of the guide duct is secured inside the first coupling element 5 of the mixer via an annular part 12 in the same manner as the single duct 8 in the first embodiment.

The wall of the first tubular duct 18a presents at least one annular internal space 19a extending substantially over its entire axial length.

The second portion 18b of the guide duct is constituted by a second tubular duct of inside diameter greater than the outside diameter of the first tubular duct 18a and having a wall that includes at least one annular space 19b extending substantially along its entire length. The top end of the second tubular duct 19b is engaged in the annular part 12 via a shell 20 and its bottom end is engaged in a part 16 inside the second coupling element 6 of the mixer and located at its outlet axial end. The free end of the first tubular duct 18a is engaged over a certain length in the free end of the second tubular duct 18b, with the first and second ducts 18a and 18b sharing the common axis 4 of the casing of the mixer.

The guide duct constituted by both the first duct portion 18a and the second duct portion 18b extends from the first coupling element 5 at one axial end of the casing of the mixer to a zone 15 situated downstream from the connection to the third coupling element which opens out to the inside of the cylindrical chamber 3 of the mixer in a position facing the outside surface of the second tubular duct 18b.

When the mixer is fed with the first fluid at 550° C. via its first axial end, the first fluid at high temperature flows (arrow 11) inside the first tubular duct 18a which opens out into the inside of the second tubular duct 18b. The cooling water introduced into the third coupling element 7 in a radial or lateral position (arrow 14) fills the annular space of the cylindrical chamber 3 between the second duct 18b and the inside surface of the casing 2 which is closed at its bottom end by the insulating part 16 in which the bottom end of the duct 18b is engaged, and it flows upwards to the top portion of the shell 20 that is pierced by openings 20′. The flow of cooling water passing inside the shell 20 reverses so that it then flows downwards and penetrates into the annular space between the first tubular duct 18a and the second tubular duct 18b. The cooling water mixes with the high temperature first fluid in the mixing zone at the outlet, from the first tubular duct 18a. The mixture is recovered via the outlet opening from the mixer at the second coupling element 6.

In the second embodiment, the portion of, the casing 2 of the mixer situated between a shoulder 2a and the second coupling element 6 is substantially at the same temperature as the cooling water (close to 20° C.).

The first coupling element 5 is at a temperature close to the temperature of the first fluid (550° C.). The maximum temperature gradient in the axial direction is located in a cylindrical zone 2b of the casing between the first coupling element 5 and the shoulder 2a. A steep temperature gradient in the axially symmetrical zone 2b of the casing presents no drawback for the behavior of the casing of the mixer in operation. The coupling elements 5, 6, and 7 are at temperatures that are uniform and the coupling elements 5 and 7 are spaced apart from each other by an axial distance that is a little less than the total length of the casing 2 of the mixer.

In addition, as before, the temperature differences through the first tubular duct 18a and through the second tubular duct 18b are absorbed for the most part by at least one insulating layer of stagnant water inside the corresponding annular space 19a or 19b of the tubular duct 18a or 18b.

It should be observed that the temperature difference across the wall of the first tubular duct 18a whose inside surface is in contact with the first fluid at high temperature and whose outside surface in contact with the cooling water is substantially greater than the temperature difference across the wall of the second tubular duct 18b whose inside surface is in contact with the fluid mixture at about 300° C. and whose outside surface is in contact with the cooling water at 20° C. that fills the outer annular portion of the cylindrical chamber 3 of the mixer.

In the second embodiment, the zone 15 situated downstream from the third coupling element, at the outlet from the guide duct, receives the fluid mixture, with the mixing zone 17 then being situated upstream inside the second guide duct 18b.

FIG. 3 shows a tubular duct (e.g. the duct 18a of the device shown in FIG. 2) that has three annular insulating spaces 19′a, 19″a, 19′″a extending along the entire axial length of the portion of the duct 18a that is subjected to a large temperature difference. The coaxial annular spaces defined by the shells that are engaged one on another correspond to the single annular space 19a shown in simplified manner in FIG. 2.

As can be seen in FIG. 3, the first set of shells constituting the first tubular duct 18a comprises an inner shell 21 and three outer shells 22a, 22b, and 22c engaged one on another and also on the inner shell 21 in a coaxial configuration.

Each of the shells 21, 22a, and 22b has a portion extending over an axial length L in which the shell presents reduced thickness. When the shells are engaged on one another during assembly of the first tubular duct 18a, the annular spaces 19′a, 19″a, and 19′″a are thus formed respectively between the shells 21 & 22a, 22a & 22b, and 22b & 22c in the portion of the duct that is subjected to a steep temperature gradient. In addition, the outer shells 22a, 22b, and 22c are pierced through their entire thicknesses by small-diameter openings (e.g. having a diameter of 2 mm) that are distributed circumferentially in two zones 23 and 23′ at the ends of the zone of length L over which the shells 21, 22a, and 22b are of reduced thickness, i.e. at the axial ends of the annular spaces 19′a, 19″a, and 19′″a. When the tubular duct 18a is assembled in the device shown in FIG. 2, the shells 21, 22a, 22b, and 22c that have diametrically enlarged portions at their top ends that are engaged on one another come to rest in an annular groove of the sleeve part 12, with the portions of length L of the shells between which the annular spaces 19′a, 19″a, and 19′″a are formed being engaged inside the inner shell 20 of the second tubular duct 18b. The openings disposed in the zones 23 and 23′ of the shells put the annular spaces 19′a, 19″a, and 19′″a into communication with an annular zone of the mixer chamber inside the shell 20 of the second tubular duct 18b that receives the cooling water via the openings 20′. The annular spaces 19′a, 19″a, and 19′″a are filled with water that is practically stagnant, which water penetrates into the annular spaces via the openings in the zones 23 and 23′. The inner shell 21 completely isolates the inside portion of the first tubular duct 18a that receives the first fluid at high temperature from the annular spaces 19′a, 19″a, and 19′″a and from the zone for receiving cooling water outside the first tubular duct 18.

The second duct 18b is analogous to the first duct 18a and is constituted by shells that are engaged one on another; the shells of the second duct 18b present portions of reduced thickness, extending substantially along their entire length that is subjected to a large temperature difference, and the inner shell 20 is extended from the top end of the duct 18b and presents the through openings 20′.

As can be seen in FIGS. 4A and 4B, when using a uniform wall 18 made of any one material which is subjected on a first face to a first temperature and on a second face to a second temperature lower than the first, the temperature gradient can be represented by the slope of a straight line 26 which may be very steep in the event of a very great temperature difference between the two faces of the wall 18. When temperature gradients are very steep, it is not possible to use any solid material (such as a metal or a refractory material) without that material suffering damage.

FIG. 4B shows a wall element 18′ constituted by a first wall element 18′a, a second wall element 18′b, and a third wall element 18′c which are disposed parallel to one another, leaving a first space 19′ab between the elements 18′a and 18′b and a second space 19′bc between the elements 18′b and 18′c, the spaces 19′ab and 19′bc being filled with an insulating material. Under such circumstances, the temperature gradient is represented by the slopes of a broken line 26′ having straight portions within the solid wall elements 18′a, 18′b, and 18′c having shallow slopes and straight portions in the spaces filled with the insulating material having steep slopes. Under such circumstances, the temperature gradients inside the wall elements 18′a, 18′b, and 18′c of the composite wall 18′ are greatly reduced.

When using tubular cylindrical elements, the wall 18 and the wall elements 18′a, 18′b, and 18′c are in the form of coaxial tubular casings. When these tubular cylindrical walls are subjected to steep radial temperature gradients, they present radial and circumferential stresses that can exceed the rupture limit of the casing and lead to damage of the wall of the component. These stresses are functions of the temperature gradients, the characteristics of the material (modulus of elasticity, Poisson coefficient, and expansion coefficient) and of the dimensions of the tube (radius and thickness). With very steep temperature gradients, no solid material can be used without it suffering damage. A tubular casing such as the casing 18 therefore cannot be used in association with steep temperature gradients.

When using a composite casing as shown in FIG. 4B, the wall elements 18′a, 18′b, and 18′c are subjected to shallow temperature gradients only, so they can be designed to withstand these temperature gradients, leaving the insulating layers in the spaces 19′ab and 19′bc to be subjected to very steep temperature gradients, such that it could be difficult to find insulating materials capable of withstanding the stresses at such temperature gradients.

When the two sides of the wall are in contact with fluids at different temperatures, the insulating spaces 19′ab and 19′bc of the wall 18′ can be filled with the lower temperature fluid by providing openings passing through the wall elements 18′b and 18′c, for example. One of the fluids used in the method is then used as a thermal insulator, by creating a layer of fluid between two wall elements. To obtain a layer of fluid having satisfactory characteristics, critical thicknesses are defined for the spaces 19′ab and 19′bc below which no natural convection can occur within the process fluid filling the spaces 19′ab and 19′bc. Under such circumstances, only the thermal conductivity of the fluid is involved. Depending on the overall temperature difference implemented in the method, and on the number of insulating layers (e.g. two or three insulating layers as in the embodiment described above), these thicknesses can be very small, e.g. less than 1 millimeter.

Such walls, as shown in FIG. 4B, can be used as walls for separating fluids at temperatures that are very different, and in particular they can be used as the walls of mixture guide ducts in accordance with the invention.

The invention thus relates to a mixer device enabling fluids at very different temperatures to be mixed together effectively, while avoiding the effects of steep temperature gradients in the separation walls of the mixer.

The invention is not limited to the embodiment described above.

Thus, the mixer of the invention may have a casing of a shape different from those described, and may have one or more guide ducts inside the casing of the mixer for guiding flow between streams of fluid at different temperatures.

When cooling a residual fluid from an operation of treating effluent by oxidation in water in the supercritical state, the residual fluid can be simultaneously cooled and neutralized, e.g. by injecting cooling water that contains caustic soda.

The invention can be applied to cooling fluids other than the residual fluids from an operation of oxidizing effluent in supercritical water.

The invention can also be applied to mixing fluids at very different temperatures in numerous industries, and in particular in the chemical industry. The invention can also have applications in installations for producing energy.

What is claimed is:

1. A device for mixing a first fluid at a first temperature with a second fluid at a second temperature, the fluids being mixed in the form of coaxial streams flowing in the same direction, the device comprising a generally cylindrical tubular casing having a substantially rectilinear axis defining a cylindrical mixer chamber coaxially inside the casing and comprising, at a first axial end, a first coupling element for coupling to first fluid feed means, and at a second axial end, opposite from the first, a second coupling element for coupling to means for exhausting the mixture of the first and second fluids, and at least one guide duct for guiding at least one of the first and second fluids, the at least one duct being substantially rectilinear and disposed coaxially inside the mixer chamber, the device including a third coupling element for coupling the mixer chamber to second fluid feed means, the third coupling element being in a position in the axial direction that is intermediate between the first and second coupling elements and extending in a transverse direction that is substantially perpendicular to the axial direction, and the guide duct extends axially in the mixer chamber between the first coupling element and a zone of the mixer casing downstream from the third coupling element in the direction going from the first coupling element to the second, and comprises a tubular wall including at least one coaxial insulating internal annular space in communication with a zone of the mixer chamber, said space extending substantially over the entire length of the guide duct, the third coupling element opening out into the mixer chamber so as to face an outside surface of the wall of the guide duct.

2. A device according to claim 1, wherein the guide duct comprises both a first tubular duct extending axially inside the mixer chamber from the first coupling element at one axial end of the mixer chamber and a second tubular duct having a diameter greater than the outside diameter of the first tubular duct and disposed coaxially relative to the first tubular duct and the mixer casing, having a first axial end inside the cylindrical chamber with an end portion of the first tubular duct engaged therein, and a second axial end downstream from the third coupling element that opens out into the mixer chamber facing the outside surface of the wall of the second tubular duct, in such a manner that the second fluid introduced into the mixer chamber via the third coupling element flows in an annular zone of the mixer chamber that is closed at the second axial end of the second tubular duct, flowing axially towards the first end of the second tubular duct, and then, in the opposite direction, inside the second tubular duct between the first and second axial ends of the second tubular duct, the first and second fluids mixing in the form of coaxial streams flowing in the same direction in a mixing zone inside the second tubular duct.

3. A device according to claim 2, wherein each of the first and second tubular ducts is constituted by a set of coaxial shells engaged one on another and including wall portions of reduced thickness so as to leave between them coaxial annular spaces, and pierced by openings putting the coaxial annular spaces into communication with a medium outside the tubular duct in the mixer chamber.

4. A device according to claim 3, wherein the second tubular duct includes an inner shell projecting from one of its axial ends relative to the set of shells of the second tubular duct in order to be engaged around the first tubular duct with radial clearance and pierced by openings for passing fluid into an annular space between the outer surface of the first tubular duct and the inner surface of the inner shell of the second tubular duct.

5. The use of a mixer device according to claim 1, for mixing a first fluid mainly constituted by supercritical water used for treating effluents by oxidation in supercritical water, together with a second fluid mainly constituted by cooling water at a temperature that is substantially less than the temperature of the first fluid.

6. A use according to claim 5, wherein the first fluid is at a temperature of 550° C. and the second fluid at a temperature of about 20° C.
